(19) United States
(12) Patent Application Publication
(10) Pub. No.: US 2025/0309389 A1
(43) Pub. Date: Oct. 2, 2025

(54) METHOD OF MANUFACTURING REGENERATED POSITIVE ELECTRODE

(71) Applicant: HONDA MOTOR CO., LTD., Tokyo (JP)

(72) Inventors: Taichiro Sato, Wako-shi (JP); Takeshi Muro, Wako-shi (JP); Kenta Urata, Wako-shi (JP); Takashi Higono, Wako-shi (JP); Shuichi Kazuno, Wako-shi (JP); Tomohiro Inoue, Wako-shi (JP); Sae Ishihara, Wako-shi (JP)

(21) Appl. No.: 19/059,374

(22) Filed: Feb. 21, 2025

(30) Foreign Application Priority Data
Mar. 29, 2024 (JP) 2024-057518

(51) Int. Cl. H01M 10/54; B09B 3/32; B09B 3/70; B09B 3/80; B09B 101/16; H01M 4/02; H01M 4/04

(52) U.S. Cl. CPC H01M 10/54; B09B 3/32; B09B 3/70; B09B 3/80; H01M 4/043; H01M 4/0459; B09B 2101/16; H01M 2004/028

(57) ABSTRACT

Provided is a method of manufacturing a regenerated positive electrode in a used lithium ion secondary battery including a laminate having a positive electrode, any one of a separator and a solid electrolyte layer, and a negative electrode, the method of manufacturing a regenerated positive electrode including extracting the positive electrode from the laminate, pressing the extracted positive electrode, and doping the pressed positive electrode with lithium ions, the doping of the lithium ions being performed by a discharge using a lithium electrode as a counter electrode in an electrolyte.

### CROSS-REFERENCE TO RELATED APPLICATION

Priority is claimed on Japanese Patent Application No. 2024-057518, filed Mar. 29, 2024, the content of which is incorporated herein by reference.

### BACKGROUND OF THE INVENTION

### Field of the Invention

The present invention relates to a method of manufacturing a regenerated positive electrode.

### Description of Related Art

In recent years, research and development has been being conducted into reuse of lithium ion secondary batteries to contribute to energy efficiency, so that more people can have access to affordable, reliable, sustainable and advanced energy.

For example, Japanese Unexamined Patent Application, First Publication No. 2012-022969 discloses a method of regenerating electrodes of a lithium ion battery including a process of treating at least one of positive and negative electrodes of a lithium ion secondary battery after use using polar solvent, a process of drying the solvent-treated electrode, and a process of refilling a battery having the dried electrode.

For example, Japanese Unexamined Patent Application, First Publication No. 2006-228510 discloses a method of reusing a negative electrode plate for a non-aqueous electrolyte secondary battery including extracting a negative electrode plate from a non-aqueous electrolyte secondary battery using a carbon material as a negative electrode active material, cleaning the plate using a water-containing liquid, and reusing the plate after drying.

### SUMMARY OF THE INVENTION

In the technology related to reuse of the secondary battery disclosed in Japanese Unexamined Patent Application, First Publication No. 2012-022969, although it is possible to remove a deteriorated positive electrode active material surface of the positive electrode, it is not possible to recover from an increased resistance due to a decrease in adhesion level of particles or the like of the positive electrode active material, or a decreased capacity due to a decrease in lithium on the positive electrode. Japanese Unexamined Patent Application, First Publication No. 2006-228510 does not disclose a method of reusing a positive electrode.

An aspect of the application is directed to recovering from an increase in resistance due to a decrease in adhesion level of particles or the like of a positive electrode active material, or recovering from a decrease in capacity due to decrease in lithium of a positive electrode.

The present invention has the following aspects.
(1) A method of manufacturing a regenerated positive electrode in a used lithium ion secondary battery including a laminate having a positive electrode, any one of a separator and a solid electrolyte layer, and a negative electrode, the method of manufacturing a regenerated positive electrode including: extracting the positive electrode from the laminate; pressing the extracted positive electrode; and doping the pressed positive electrode with lithium ions, wherein the doping of the lithium ions are performed by a discharge using a lithium electrode as a counter electrode in an electrolyte.

According to the aspect, by pressing the positive electrode, it is possible to recover from the increase in resistance caused by the decrease in the adhesion level of particles of the positive electrode active material, and by doping lithium ions onto the pressed positive electrode, it is possible to recover from the decrease in capacity caused by the decrease in lithium on the positive electrode. In addition, by pressing the positive electrode and doping the lithium ion in that order, the lithium ion doping can be made uniform. In addition, it is possible to manufacture the regenerated positive electrode more efficiently.
(2) The method of manufacturing a regenerated positive electrode according to the above-mentioned (1), wherein the positive electrode is cleaned with an organic solvent before the pressing.

According to the above-mentioned aspect, by cleaning the positive electrode with organic solvent, it is possible to recover from the increased resistance due to the thin film containing lithium formed on the positive electrode.
(3) The method of manufacturing a regenerated positive electrode according to the above-mentioned (1) or (2), wherein the laminate extracted from the lithium ion secondary battery is cleaned with the organic solvent, and the positive electrode is extracted from the laminate which was cleaned with the organic solvent.

According to the above-mentioned aspect, cleaning using the organic solvent can be performed using small equipment, and the amount of organic solvent used and the amount of waste liquid are reduced, making it possible to perform the process more efficiently and economically.
(4) The method of manufacturing a regenerated positive electrode according to any one the above-mentioned (1) to (3), wherein the positive electrode is pressed so that a thickness of the positive electrode after pressing becomes 85 to 100% of a thickness of the positive electrode before use.

According to the above-mentioned aspect, the recovery effect for the increased resistance due to the decrease in the adhesion level of the particles of the positive electrode active material is further enhanced.
(5) The method of manufacturing a regenerated positive electrode according to any one of the above-mentioned (1) to (4), wherein the laminate is wound around.

According to the above-mentioned aspect, it is possible to maximize the recovery effect in the other aspects mentioned above.

According to each of the above-mentioned aspects of the present invention, it is possible to recover from the increase in resistance caused by the decrease in adhesion level of particles of the positive electrode active material, or the decrease in capacity caused by the decrease in lithium on the positive electrode. In addition, this will enable more efficient reuse of secondary batteries.

### BRIEF DESCRIPTION OF THE DRAWINGS

FIG. 1 is a schematic cross-sectional view showing an example of a layer structure of a laminate in a lithium ion secondary battery according to an embodiment of the present invention.

FIG. 2 is a schematic cross-sectional view showing an example of a layer structure of a laminate in a lithium ion secondary battery according to another embodiment of the present invention.

FIG. 3 is a flowchart of a method of manufacturing a regenerated positive electrode according to a first embodiment of the present invention.

FIG. 4 is a flowchart of a method of manufacturing a regenerated positive electrode according to another first embodiment of the present invention.

### DETAILED DESCRIPTION OF THE INVENTION

Hereinafter, while embodiments of the present invention will be described in detail, the following description is an example of the embodiment of the present invention, and the present invention is not limited to these contents and can be modified and implemented within the scope of the present invention.

A method of manufacturing a regenerated positive electrode of the embodiment is a method of manufacturing a regenerated positive electrode in a lithium ion secondary battery including a laminate having a positive electrode, any one of a separator and a solid electrolyte layer, and a negative electrode. That is, the lithium ion secondary battery of the embodiment includes a lithium ion secondary battery in which an electrolyte is a liquid (hereinafter, referred to as “a liquid electrolyte lithium ion secondary battery”), and a lithium ion secondary battery in which an electrolyte is a solid (hereinafter, referred to as “an all solid lithium ion secondary battery”).

The method of manufacturing a regenerated positive electrode includes extracting the positive electrode from the laminate, pressing the extracted positive electrode (hereinafter, also referred to as “pressing treatment”), and doping the pressed positive electrode with lithium ions (hereinafter, also referred to as “a lithium ion doping treatment”). Doping of the lithium ions is performed by discharging the electrolyte using a lithium electrode as a counter electrode.

### <Lithium Ion Secondary Battery>

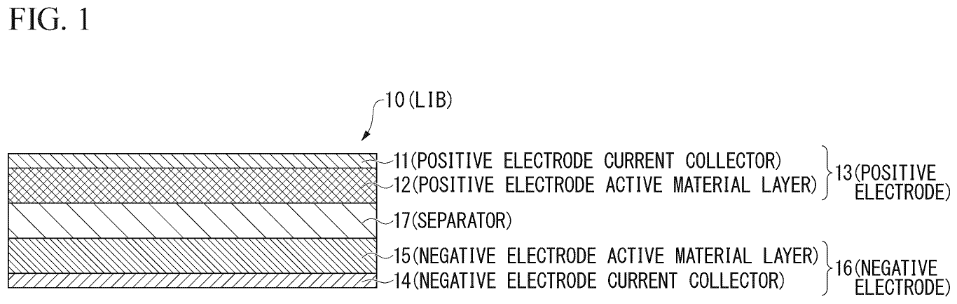

FIG. 1 is a schematic cross-sectional view showing an example of a layer structure of a laminate in a lithium ion secondary battery (liquid electrolyte lithium ion secondary battery) according to the embodiment.

A lithium ion battery 10 (LIB) is obtained by sequentially laminating a positive electrode 13, a separator 17, and a negative electrode 16. The positive electrode 13 is constituted by a positive electrode current collector 11, and a positive electrode active material layer 12 provided on a surface of the positive electrode current collector 11. Further, in FIG. 1, while the positive electrode active material layer 12 is provided on only one surface of the positive electrode current collector 11, it may be provided on both surfaces. The negative electrode 16 is constituted by a negative electrode current collector 14, and a negative electrode active material layer 15 provided on a surface of the negative electrode current collector 14. Further, in FIG. 1, while the negative electrode active material layer 15 is provided on only one surface of the negative electrode current collector 14, it may be provided on both surfaces. In addition, in FIG. 1, an electrode group includes only one each of the positive electrode 13 and the negative electrode 16, but may also be a group of electrodes in which a plurality of positive electrodes 13 and negative electrodes 16 are laminated alternately. Even in this case, the separator 17 is installed between the positive electrode 13 and the negative electrode 16.

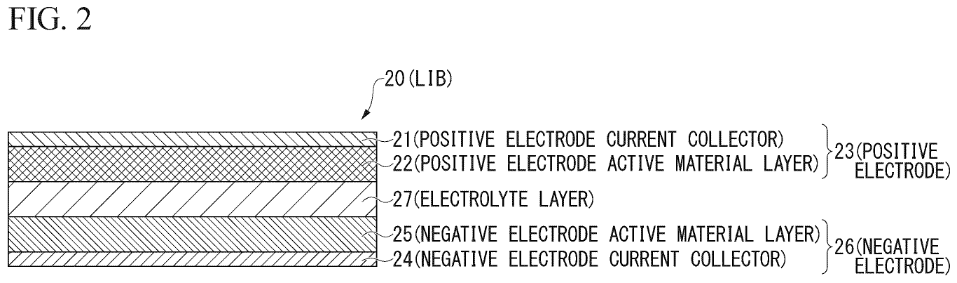

FIG. 2 is a schematic cross-sectional view showing an example of a layer structure of a laminate in a lithium ion secondary battery (all solid lithium ion secondary battery) according to another embodiment.

A lithium ion battery 20 (LIB) is obtained by sequentially laminating a positive electrode 23, an electrolyte layer 27, and a negative electrode 26. The positive electrode 23 is constituted by a positive electrode current collector 21, and a positive electrode active material layer 22 provided on a surface of the positive electrode current collector 21. Further, in FIG. 2, while the positive electrode active material layer 22 is provided on only one surface of the positive electrode current collector 21, it may be provided on both surfaces. The negative electrode 26 is constituted by a negative electrode current collector 24, and a negative electrode active material layer 25 provided on a surface of the negative electrode current collector 24. Further, in FIG. 1, while the negative electrode active material layer 25 is provided on only one surface of the negative electrode current collector 24, it may be provided on both surfaces. In addition, in FIG. 2, an electrode group includes only one each of the positive electrode 23 and the negative electrode 26, but may also be a group of electrodes in which a plurality of positive electrodes 23 and negative electrodes 26 are laminated alternately. Even in this case, the electrolyte layer 27 is installed between the positive electrode and the negative electrode.

### (Positive Electrode Active Material Layer)

The positive electrode active material layer 12 (22) includes a positive electrode active material, a conductive additive, and a binder. Further, when the positive electrode active material has conductivity, the positive electrode active material layer does not have to contain a conductive additive.

There are no particular limitations on the positive electrode active material, so long as it is capable of absorbing and releasing lithium ions. Examples of the positive electrode active material include lithium nickel oxide (for example, LiNiO₂), lithium cobalt oxide (for example, LiCoO₂), lithium nickel cobalt oxide, lithium nickel cobalt manganese oxide, LiFePO₄, LiMnpxFexPO₄, LiMnPO₄, LiCoPO₄, LiNiPO₄, and the like. The positive electrode active material preferably contains one or more selected from the group consisting of manganese, nickel, and cobalt.

The conductive additive aids in formation of a conductive path between the positive electrode active material and the positive electrode current collector 11 (21). There are no particular limitations on the conductive additive as long as it has conductivity, and examples include carbon black such as acetylene black, carbon nano tubes, graphite such as artificial graphite, and the like.

The binder bonds the positive electrode active material, the conductive additive, and the positive electrode current collector 11 (21). Examples of the binder include polyvinylidene fluoride (PVDF), polytetrafluoroethylene (PTFE), polyamide (PA), polyimide (PI), polyacrylic acid and copolymer thereof, polyamideimide (PAI), polybenzimidazole, polyethersulfone (PES), maleic anhydride modified polypropylene and a mixture thereof. The binder preferably contains a crystalline polymer having a melting point. The binder is preferably a polymer containing fluorine. The polymer that contains fluorine includes PVDF, PTFE, or the like.

### (Positive Electrode Current Collector)

The positive electrode current collector 11 (21) is, for example, aluminum foil, stainless steel foil, nickel foil, and other metal foils. The positive electrode current collector 21 may have a carbon coating layer formed thereon. In addition, the positive electrode current collector 11 (21) may be machined into a mesh shape.

### (Negative Electrode Active Material Layer)

The negative electrode active material layer 15 (25) includes a negative electrode active material, a conductive additive, and a binder. Further, when the negative electrode active material has conductivity, the negative electrode active material layer does not need to contain a conductive additive.

There are no particular limitations on the negative electrode active material, as long as it is capable of absorbing and releasing lithium ions. Examples of the negative electrode active material include graphite (artificial graphite, natural graphite), amorphous carbon (hard carbon), meso-carbon microbeads, carbon fiber, Si material (silicon, Si alloy, Si oxide), and the like.

The conductive additive aids in formation of a conductive path between the negative electrode active material and the negative electrode current collector 14 (24). There are no particular limitations on conductive additives as long as they have conductivity, and examples include carbon black such as acetylene black, carbon nano tubes, graphite such as artificial graphite, and the like.

The binder bonds the negative electrode active material, the conductive additive, and the negative electrode current collector 14 (24). Examples of the binder include carboxymethyl cellulose, polyvinylidene fluoride, polytetrafluoroethylene, polyacrylic acid, fluorine rubber, diene-based rubber such as styrene butadiene rubber, or the like. The binder preferably contains a crystalline polymer having a melting point. The binder is preferably a polymer containing fluorine. The polymer that contains fluorine includes PVDF, PTFE, fluorine rubber, and the like.

The negative electrode current collector 14 (24) is, for example, metal foil such as copper foil, stainless steel foil, and nickel foil. A carbon coating layer may be formed on the negative electrode current collector 14 (24). In addition, the negative electrode current collector 14 (24) may be machined into a mesh shape.

### (Electrode Tab)

In order to extract the current outside the battery, the positive electrode current collector 11 (21) and the negative electrode current collector 14 (24) may each be connected to electrode tabs (not shown). The electrode tabs are electrically connected to these current collectors and, for example, extracted to the outside of the exterior body of the lithium ion secondary battery.

The material constituting the electrode tab is not particularly limited, and a known high conductivity material that has been conventionally used as an electrode tab is preferably used. The material constituting the electrode tab is preferably a metal material such as aluminum, copper, titanium, nickel, stainless steel, or an alloy of these metals, and more preferably aluminum or copper from the viewpoints of light weight, corrosion resistance, and high conductivity.

### (Exterior Body)

The laminate is housed in the exterior body (not shown). In the case of the liquid electrolyte lithium ion secondary battery, the exterior body is filled with the electrolyte. The exterior body can be a known metal can case, or a bag-shaped case made of laminate film containing aluminum that can cover the power generation element. The laminate film may be, for example, a three-layered structure laminate film made by laminating polypropylene, aluminum, and nylon in that order. From the viewpoint that the laminate film has excellent high output and cooling performance and can be preferably used for large equipment batteries for EV and HEV, it is desirable to use the laminate film for the exterior body.

The positive and negative electrode terminal leads (both not shown) connected to the electrode tabs can also be used as needed. The materials for the positive electrode terminal lead and the negative electrode terminal lead can be any known material. Further, the parts extracted from the exterior body are preferably covered with a heat shrinkage tube with heat resistant insulation to prevent them from coming into contact with peripheral devices or wiring, which could cause electrical leakage and adversely affect the product (for example, vehicle parts, in particular, electronic instruments or the like). In addition, in a wound-type lithium ion secondary battery, the terminals may be formed using, for example, a cylindrical can (metal can) instead of the electrode tab.

### (Electrolyte)

The electrolyte contains electrolyte and organic solvent.

The electrolyte can be selected any electrolyte known in the art, for example, lithium salt such as LiClO₄, LiPF₆, LiAsF₆, LiSbF₆, LiBF₄, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, or the like.

The above-mentioned electrolytes may be used alone or in combination of two or more.

As the organic solvent, any organic solvent known in the art can be selected, such as carbonate such as propylene carbonate, ethylene carbonate, dimethyl carbonate, diethyl carbonate, ethyl methyl carbonate, 4-trifluoromethyl-1,3-dioxolan-2-one, 1,2-di(methoxycarbonyloxy) ethane; esters such as methyl formate, methyl acetate, and 7-butyrolactone; ether such as 1,2-dimethoxyethane, 1,3-dimethoxypropane, pentafluoropropyl methyl ether, 2, 2, 3, 3-tetrafluoroethylene propyl difluoromethyl ether, tetrahydrofuran, 2-methyltetrahydrofuran; amides such as N,N-dimethylformamide, N,N-dimethylacetamide; nitriles such as acetonitrile and butyronitrile; carbamates such as 3-methyl-2-oxazolidone; sulfur-containing compounds such as sulfolane, dimethyl sulfoxide, 1,3-propane sultone, and the like.

The above-mentioned organic solvents may be used alone or in combination of two or more.

### (Separator)

Examples of the separator 17 include separators made of olefin resins such as polyethylene and polypropylene, fluorine resins, and aromatic resins containing nitrogen atoms. Examples of forms include porous membranes, nonwoven fabrics, and woven fabrics.

### (Solid Electrolyte)

Examples of the solid electrolyte of the solid electrolyte layer 27 include inorganic solid electrolyte and organic solid electrolyte. As the inorganic solid electrolyte and the organic solid electrolyte, those known in the art can be used. Examples of the inorganic solid electrolytes include oxides that contain oxygen atoms and have both lithium ion conductivity and electric insulation, and oxides that contain sulfur atoms and have both lithium ion conductivity and electric insulation. The organic solid electrolyte can be a polymer compound that exhibits ion conductivity. For example, polyethylene oxide, polypropylene oxide, copolymers thereof, and the like, can be used. In addition, the organic solid electrolyte may be in the form of a gel containing the electrolyte.

### <<Method of Manufacturing Regenerated Positive Electrode>>

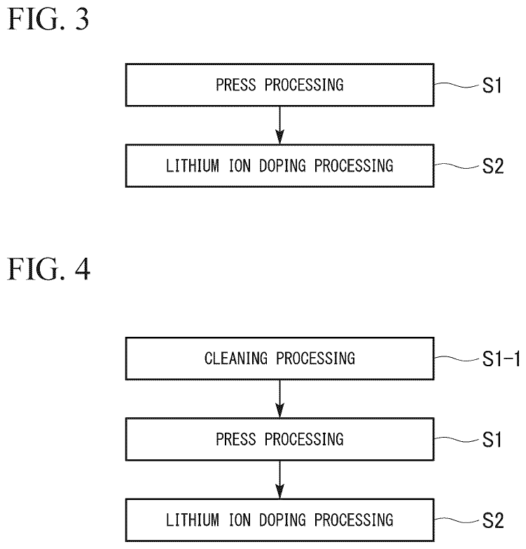

A method of manufacturing a regenerated positive electrode includes extracting the positive electrode from the laminate contained in the lithium ion secondary battery, pressing the extracted positive electrode (pressing treatment), and doping the pressed positive electrode with lithium ions (lithium ion doping treatment). The lithium ions are doped into the electrolyte by discharging them using a lithium electrode as a counter electrode. FIG. 3 is a flowchart of a method of manufacturing a regenerated positive electrode according to a first embodiment of the present invention.

### <Pressing Treatment>

In pressing treatment Si, the positive electrode 13 (23) is pressed in the thickness direction of the positive electrode 13 (23). The pressing can be performed by a known means such as a roll press. The pressing pressure is preferably be set so that the positive electrode thickness after pressing is 85 to 100% of the thickness of the positive electrode before use (the positive electrode at the time of manufacture), and it is even more preferable that the positive electrode thickness after pressing is 95 to 100% of the thickness of the positive electrode before use (the positive electrode at the time of manufacture).

In the pressing treatment S1, it is preferable to perform pressing while heating. By pressing the electrode while heating, the binder contained in the positive electrode active material layer is softened, making it easier to regenerate the adhesive force. The heating temperature is, for example, preferably the melting point or more of the binder to 200° C. or less, more preferably the melting point or more and 170° C. or less.

It is preferable to press the electrode until it has the same thickness as the positive electrode before use (the positive electrode at the time of manufacture). When the lithium ion secondary battery is repeatedly charged and discharged, the adhesion level of particles of the positive electrode active material and particles of the conductive additive decreases, causing the thickness to increase and the resistance to increase. In the pressing treatment Si, the pressing improves the adhesion level of the particles of the positive electrode active material and the particles of the conductive additive, thereby reducing the resistance and recovering from the function of the positive electrode.

It is preferable to previously acquire the thickness of the positive electrode before use.

For the thickness of the positive electrode (the positive electrode at the time of manufacture) before use, if there is information available on the thickness of the positive electrode at the time of manufacture of a lithium ion secondary battery, the information is used. When the information is not available, for example, a thickness obtained by subtracting the void portion of the positive electrode from the thickness of the used positive electrode may be used as the estimated thickness.

In the pressing treatment S1, it is preferable that the method further comprises applying a conductive agent to the surface of the positive electrode 13 (23). The conductive agent is not particularly limited, but may be, for example, a carbonous material such as acetylene black or carbon nano tubes. As the conductive agent, carbon fiber is preferred. By applying the conductive agent, the conductivity can be compensated and the resistance of the positive electrode active material layer can be reduced by adding the conductive agent.

There is no particular limitation on the method of applying the conductive agent. For example, the conductive agent may be dispersed in a dispersion liquid, which may then be applied and dried. In addition, in the application process, it is preferable to apply ultrasonic waves. By applying the ultrasonic waves, the conductive agent can penetrate into the void inside the positive electrode 13 (23), further reducing the resistance. Accordingly, it is possible to improve and recover from the state of the positive electrode.

Application of the conductive agent is preferably performed prior to pressing the positive electrode 13 (23). That is, it is preferable to apply the conductive agent to the surface of the positive electrode 13 (23) and then press the positive electrode 13 (23).

### <Lithium Ion Doping Treatment>

In lithium ion doping treatment S2, during the discharge, a lithium electrode is used as the counter electrode in the electrolyte. The lithium electrode is not particularly limited as long as it is an electrode containing lithium, and examples thereof include lithium metal, lithium alloy, and lithium metal oxide, with lithium metal being preferred. In addition, the electrode may be fixed to a current collector. As the current collector, the materials described in the positive electrode current collector and the negative electrode current collector can be used. As the electrolyte, the above-mentioned electrolytes can be used.

The positive electrode 13 (23) and the lithium electrode are placed in an electrolyte and a current is passed through them. Specifically, the current is discharged from the lithium electrode by passing the current from the lithium electrode to the positive electrode. During this process, the lithium ions move from the lithium electrode to the positive electrode 13 (23), and the positive electrode 13 (23) is doped with lithium ions.

When the lithium ion secondary battery is used, the electrolyte reacts with the lithium ions on the negative electrode, forming a thin film containing lithium on the negative electrode. In addition, some of the lithium ions are also trapped in the separator 17 and the electrolyte layer 27. This reduction in lithium ions on the positive electrode causes a decrease in the capacity of the lithium ion secondary battery. By performing the lithium ion doping treatment S2, the amount of the lithium ions in the positive electrode is recovered, and as a result, the capacity of the lithium ion secondary battery is also recovered.

There are no particular limitations on the discharge conditions, but for example, they can be discharge conditions that result in the capacity of the positive electrode before use (the positive electrode at the time of manufacture). For example, when the capacity of the positive electrode (the positive electrode at the time of manufacture) before use is x(Ah), either or both of the discharge current and discharge time can be adjusted so that a product y×z(Ah) of the discharge current y(A) and the discharge time z(h) becomes x(Ah).

### <Form of Laminate>

The laminate form of the lithium ion secondary battery according to the embodiment can be any of the conventionally known forms and structures, such as a wound type (cylindrical type) battery, a stacked type (flat type) battery, and a flat wound type (rectangular type) battery. Among these, the wound type (cylindrical type) battery and the flat wound type (rectangular type) battery are preferred, with the wound type (cylindrical type) battery being more preferred. The reason for this will be described below.

### <Mechanism of Action>

In the method of manufacturing a regenerated positive electrode of the embodiment, by pressing the positive electrode, it is possible to recover from the increased resistance caused by the decrease in the adhesion level of the particles of the positive electrode active material. In addition, by doping the pressed positive electrode with lithium ions, it becomes possible to recover from the capacity loss caused by the reduction in lithium on the positive electrode. Further, in the method of manufacturing a regenerated positive electrode of the embodiment, the pressing treatment Si and the lithium ion doping treatment S2 are performed in this order. In the lithium ion doping treatment S2, when the positive electrode is curled (wound (cylindrical) type battery) or has a crease (flat wound (rectangular) type battery), the lithium ions may not be doped uniformly. The positive electrode with which the lithium ions are not uniformly doped may have to be discarded from the viewpoint of performance, resulting in reduced yield. In addition, when performing the lithium ion doping treatment S2, it is possible to flatten the positive electrode, but this requires the use of a jig or other tool to flatten the positive electrode, which is not efficient. Meanwhile, in the method of manufacturing a regenerated positive electrode of the embodiment, the lithium ion doping treatment S2 is performed with the positive electrode flattened by the pressing treatment S1, making it easier to dope the lithium ions uniformly. In addition, in the lithium ion doping treatment S2, this is efficient because it does not require the use of the jig to flatten the positive electrode, or the jig can be simplified.

### OTHER EMBODIMENTS

The method of manufacturing a regenerated positive electrode of the embodiment may include another reproducing treatment, in addition to the pressing treatment S1 and the lithium ion doping treatment S2.

The other reproducing treatment includes, for example, cleaning treatment S1-1, which cleans the positive electrode with organic solvent. FIG. 4 is a flowchart of a method of manufacturing a regenerated positive electrode according to another first embodiment of the present invention.

As the organic solvent, a polar organic solvent is preferred. Such an organic solvent includes, for example, a protic polar solvent and a non-protic polar solvent, with the non-protic polar solvent being preferred.

Examples of the protic polar solvent include alcohols such as methanol, ethanol, n-propanol, isopropanol, 1-butanol, and 2-butanol; carboxylic acids such as formic acid, acetic acid, and propionic acid; glycols such as ethylene glycol and propylene glycol, and the like.

Example of the non-protic polar solvent include ethers such as dimethyl ether, diethyl ether, tetrahydrofuran, and ethylene glycol dimethyl ether; ketones such as acetone, methyl ethyl ketone, and cyclohexanone; esters such as ethyl acetate; carbonates such as ethyl methyl carbonate, dimethyl carbonate, diethyl carbonate, and ethylene carbonate; organic solvents containing nitrogen atoms or sulfur atoms, such as pyridine, dimethyl sulfoxide, acetonitrile, 1, 4-dioxane, and 1, 3-dioxolane, and the like.

Among these, at least one organic solvent selected from the group consisting of ketones and carbonates is preferred, and at least one organic solvent selected from the group consisting of acetone and dimethyl carbonate is more preferred.

The above-mentioned organic solvents may be used alone or in combination of two or more.

In the cleaning treatment S1-1, this is performed by immersing the positive electrode in the organic solvent. In addition, it is also possible to perform this step while performing ultrasonic wave treatment. By performing ultrasonic wave treatment, it is possible to clean the inside of the positive electrode active material. That is, the organic solvent penetrates evenly into the inside of the positive electrode active material, allowing it to be cleaned.

The cleaning time by the ultrasonic wave treatment is preferably between 10 and 100 minutes, more preferably between 20 and 60 minutes. When the cleaning time by the ultrasonic wave treatment is equal to or greater than the lower limit value, the organic solvent can be evenly penetrated into the inside of the positive electrode active material. When the cleaning time by the ultrasonic wave treatment is equal to or smaller than the upper limit value, the deterioration of the positive electrode active material layer caused by the heat generated by the ultrasonic wave can be suppressed.

It is preferable to dry the positive electrode after cleaning. The drying can be done under a condition of any one of vacuum, a reduced pressure, or a normal pressure. The drying atmosphere in the case of the reduced pressure or normal pressure may be an inert atmosphere of nitrogen or argon, or an air atmosphere.

The drying temperature is, for example, preferably 10 to 80° C., and more preferably 15 to 50° C.

The drying time is, for example, preferably between 10 and 120 minutes, more preferably between 20 and 60 minutes.

When the lithium ion secondary battery is used, the electrolyte reacts with the lithium ions on the positive electrode, forming a thin film containing lithium on the positive electrode. Such a thin film increases the resistance of the lithium ion secondary battery. By performing the cleaning treatment S1-1, the thin film is removed, resulting in recovery of the increased resistance of the lithium ion secondary battery.

The cleaning treatment S1-1 is preferably performed before the pressing treatment Si. In addition, it is preferable that the cleaning treatment S1-1 be performed on the laminate extracted from the lithium ion secondary battery. In this case, after the cleaning treatment S1-1, the positive electrode is extracted from the laminate and subjected to the pressing treatment Si.

### <Mechanism of Action>

The method of manufacturing a regenerated positive electrode of the embodiment includes the cleaning treatment S1-1, in addition to the pressing treatment S1 and the lithium ion doping treatment S2. In addition, the cleaning treatment S1-1 is performed before the pressing treatment Si. By cleaning the positive electrode with organic solvent, it is possible to recover from the increased resistance due to the thin film containing lithium formed on the positive electrode. In addition, in the method of manufacturing a regenerated positive electrode of the embodiment, the laminate is cleaned. Since the positive electrode is in a sheet form, when the positive electrode extracted from the laminate is cleaned, large equipment is required, and the amount of organic solvent used or waste liquid generated increases. Meanwhile, since the laminate is smaller than the positive electrode, it can be used in smaller equipment, and the amount of organic solvent used and waste liquid is reduced, making it more efficient and economical. In addition, the pressing treatment Si and the lithium ion doping treatment S2 require the positive electrode to be extracted, but the cleaning treatment S1-1 does not necessarily require the positive electrode to be extracted. By first performing the cleaning treatment S1-1, it is possible to clean the laminate.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A method of manufacturing a regenerated positive electrode in a used lithium ion secondary battery including a laminate having a positive electrode, any one of a separator and a solid electrolyte layer, and a negative electrode, the method of manufacturing a regenerated positive electrode comprising:
extracting the positive electrode from the laminate;
pressing the extracted positive electrode; and
doping the pressed positive electrode with lithium ions,
wherein the doping of the lithium ions are performed by a discharge using a lithium electrode as a counter electrode in an electrolyte.

2. The method of manufacturing a regenerated positive electrode according to claim 1, wherein the positive electrode is cleaned with an organic solvent before the pressing.

3. The method of manufacturing a regenerated positive electrode according to claim 2, wherein the laminate extracted from the lithium ion secondary battery is cleaned with the organic solvent, and the positive electrode is extracted from the laminate which was cleaned with the organic solvent.

4. The method of manufacturing a regenerated positive electrode according to claim 1, wherein the positive electrode is pressed so that a thickness of the positive electrode after pressing becomes 85 to 100% of a thickness of the positive electrode before use.

5. The method of manufacturing a regenerated positive electrode according to claim 1, wherein the laminate is wound around.
